(19) United States
(12) Patent Application Publication
(10) Pub. No.: US 2013/0266855 A1
(43) Pub. Date: Oct. 10, 2013

(54) METHOD OF FABRICATING CATHODE FOR LITHIUM ION SECONDARY BATTERY BY RECYCLING CATHODE ACTIVE MATERIAL AND LITHIUM ION SECONDARY BATTERY FABRICATED THEREBY

(71) Applicant: KOREA INSTITUTE OF SCIENCE AND TECHNOL, Seoul (KR)

(72) Inventors: Hyung Sun KIM, Seoul (KR); Byung Won CHO, Seoul (KR); Hwa Young LEE, Seoul (KR); Eun Jung SHIN, Gyeonggi-Do (KR)

(73) Assignee: KOREA INSTITUTE OF SCIENCE AND TECHNOLOGY, Seoul (KR)

(21) Appl. No.: 13/651,714

(22) Filed: Oct. 15, 2012

(30) Foreign Application Priority Data
Apr. 6, 2012 (KR) 10-2012-0036183

(51) Int. Cl. C23C 8/80; H01M 4/02

(52) U.S. Cl. 429/209; 148/206

(57) ABSTRACT

The present invention relates to a method for fabricating a cathode for a lithium ion secondary battery by recycling an active material, and a lithium ion secondary battery including a cathode fabricated thereby. The method according to the present invention includes: carbonizing a binder existing in a cathode scrap of a lithium ion secondary battery by heat treating the cathode scrap of the lithium ion secondary battery; collecting a cathode active material from the cathode scrap of the lithium ion secondary battery; and forming a cathode for a lithium ion secondary battery without adding a conductive material to the collected cathode active material. According to the present invention, a lithium ion secondary battery which is environmentally friendly, economical, and capable of reducing manufacturing cost can be implemented.

### CROSS-REFERENCE TO RELATED APPLICATION

This application claims priority to and the benefit of Korean Patent Application No. 2012-0036183, filed on Apr. 6, 2012, the disclosure of which is incorporated herein by reference in its entirety.

### BACKGROUND

1. Field of the Invention

The present invention relates to a method for fabricating a cathode for a lithium ion secondary battery by recycling a cathode active material and a lithium ion secondary battery fabricated thereby.

2. Discussion of Related Art

A lithium ion secondary battery having improved characteristics of high capacity, high power, and long life, is widely used for small electronic products such as electronic equipment, portable computers, and cell phones. In particular, as the issues of green growth and new renewable energy receive attention, the demand for lithium ion secondary batteries is expected to rapidly increase with commercialization of electric vehicles.

Various kinds of materials for cathode active materials for a lithium ion secondary battery have been developed. Recently, as well as conventional materials such as LiCoO₂ and ternary system active material (LiCo_{1/3}Ni_{1/3}Mn_{1/3}O₂), LiFePO₄ which is an olivine-based material, is spotlighted as a cathode active material for a high-capacity lithium ion secondary battery for an electric vehicle.

In particular, since LiFePO₄ is cheaper than other cathode active materials, it is expected that a high-capacity lithium ion secondary battery using LiFePO₄ as a cathode active material will be commercialized soon.

Although the lithium ion battery market and industry are expected to be rapidly developed, lithium (Li) metal and related compounds which are indispensable for a cathode active material, do not exist as natural resources in this country (Korea), and are thus imported from foreign countries. Therefore, it is necessary for a country lacking natural resources to collect and recycle cathode scraps generated during a fabricating process of a lithium ion secondary battery, or active materials of wasted lithium ion secondary batteries.

According to a conventional method for extracting or collecting various metals such as lithium or compounds from a cathode of a wasted lithium ion secondary battery, the cathode separated from the battery is dissolved with hydrochloric acid (HCl), sulfuric acid (H₂SO₄), or nitric acid (HNO₃), and then is neutralized with alkali in order to precipitate and collect metals such as cobalt and nickel by using hydroxide. Or, by using a solvent extraction technique, metals such as cobalt, manganese, and nickel are separated from the cathode-dissolved solution.

As described above, cobalt and nickel are main targets of collection, and lithium, which is cheaper than cobalt or nickel, is not an object of great attention. However, lithium resources are limited, and it is highly possible to use phosphate-based LiFePO₄ not containing cobalt or nickel as a cathode active material for a high-capacity lithium ion secondary battery for an electric vehicle. Therefore, collection or recycling of lithium or related compounds is expected to become a more important issue.

In addition, according to a conventional method for collecting cathode active materials, a cathode is typically dissolved in a strongly acidic solution, and then high-priced metals such as lithium, cobalt, and nickel in the solution are separated from one another to be collected. Therefore, the cost for separating metals with high purity is too high, and the evaporation of the strong acid causes serious environmental pollution. Moreover, the problem of corrosion of equipment due to the acid is serious.

In particular, since the composition of LiFePO₄ cathode scraps generated during a fabricating process of an electrode and a battery or LiFePO₄ cathode active materials contained in a wasted battery is maintained as original, the conventional chemical collecting method causes pollution and is not economic. Therefore, a new collecting method is needed.

### PRIOR ART DOCUMENTS

### Patent Documents

Patent Document 1: Korean Patent Application Publication No. 10-2012-0030865

Patent Document 2: Korean Patent Application Publication No. 10-2008-0018734

Patent document 1, which relates to a method for reprocessing a metallic-oxide-based cathode active material for a lithium ion secondary battery, discloses a method for dissolving a cathode active material of a lithium ion secondary battery by using a sulfuric acid solution containing sulfur dioxide. Patent document 2, which relates to a method for selectively eluting and extracting cobalt from a cathode active material of a wasted lithium battery, discloses a method for eluting cobalt by using ammonia water as an eluent and adding a small amount of hydrazine hydrate that is a reducing agent.

There are some patents related to recycling of oxide-based cathode active materials such as LiCoO₂ and LiNiCoMnO₂. However, according to these patents, metals such as cobalt, manganese, and nickel are separated from cathode active materials by using a solvent extraction technique using a strong acid or strongly alkaline solvent, thereby resulting in high cost, serious environmental pollution, and corrosion of equipment.

### SUMMARY OF THE INVENTION

The present invention is directed to a method for fabricating a cathode for a lithium ion secondary battery by recycling a cathode active material, and a lithium ion secondary battery fabricated thereby.

According to an aspect of the present invention, there is provided a method for fabricating a cathode for a lithium ion secondary battery by recycling a cathode active material, the method including: carbonizing a binder existing in a cathode scrap of a lithium ion secondary battery by heat treating the cathode scrap of the lithium ion secondary battery; collecting a cathode active material from the cathode scrap of the lithium ion secondary battery; and forming a cathode for a lithium ion secondary battery without adding a conductive material to the collected cathode active material.

The cathode for the lithium ion secondary battery for the carbonizing of the binder may include a conductive thin plate and a cathode active material layer formed on the conductive thin plate, and the cathode active material layer may include the cathode active material, conductive material, and binder.

The conductive thin plate may be a conductive metal thin plate.

The conductive metal thin plate may include at least one selected from the group consisting of an aluminum thin plate, a copper thin plate, a gold thin plate, a silver thin plate, and a platinum thin plate.

The cathode active material may include LiFePO₄.

The heat treatment may be performed at a temperature of about 400° C. to about 600° C.

The heat treatment may be performed at a temperature of about 450° C. to about 550° C.

The heat treatment for carbonizing of the binder may be performed in an atmosphere of reducing gas or inert gas.

Hydrogen gas may be used as the reducing gas.

Nitrogen gas or argon gas may be used as the inert gas.

The collecting of the cathode active material may include grinding and sieving.

The forming of the cathode may include adding a binder.

About 80 to 95 wt % of the cathode active material and about 5 to 20 wt % of the binder may be added, and the total amount of the cathode active material and binder may be 100 wt %.

The binder may include a polymer solution in which sodium carboxymethyl cellulose (1 wt % in water) and styrene butadiene rubber (40 wt % in water) are mixed.

According to another aspect of the present invention, there is provided a lithium ion secondary battery including a cathode fabricated by a method including: carbonizing a binder existing in a cathode scrap of a lithium ion secondary battery by heat treating the cathode scrap of the lithium ion secondary battery; collecting a cathode active material from the cathode scrap of the lithium ion secondary battery; and forming a cathode for a lithium ion secondary battery without adding a conductive material to the collected cathode active material.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a mimetic diagram illustrating a process of fabricating a cathode of a lithium ion secondary battery by recycling a cathode active material according to an exemplary embodiment of the present invention;

FIGS. 2 and 3 illustrate charge/discharge voltage characteristics of lithium ion secondary batteries according to examples 1 to 3 of the present invention and a comparative example; and

FIG. 4 is a graph illustrating the cycle performance of the lithium ion secondary batteries according to examples 1 to 3 of the present invention and a comparative example.

### DETAILED DESCRIPTION OF EXEMPLARY EMBODIMENTS

Hereinafter, exemplary embodiments of the present invention will be described with reference to the accompanying drawings.

The present invention may, however, be embodied in different forms and should not be construed as limited to the embodiments set forth herein.

Rather, these embodiments are provided so that this disclosure will be thorough and complete, and will fully convey the scope of the present invention to those skilled in the art. In the drawings, shapes and sizes of elements may be exaggerated for clarity of illustration. Throughout the specification and drawings, like reference numerals denote like elements.

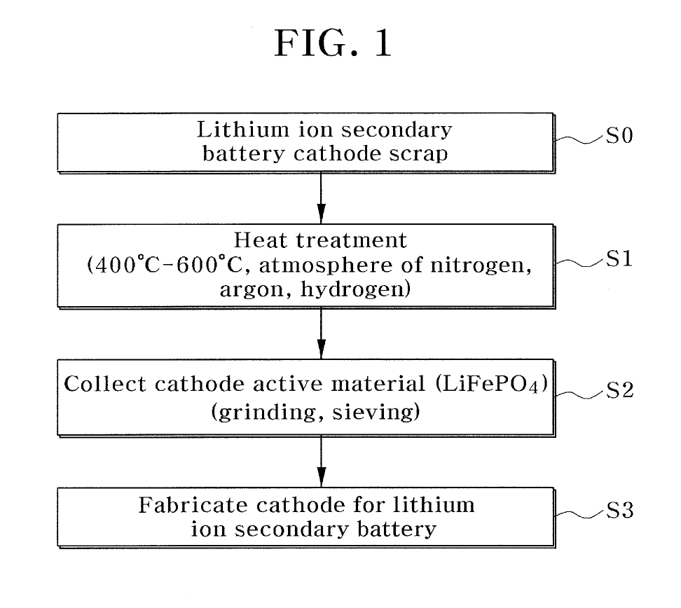

FIG. 1 is a flowchart illustrating a process of fabricating a cathode of a lithium ion secondary battery by recycling a cathode active material according to an exemplary embodiment of the present invention.

Referring to FIG. 1, according to an exemplary embodiment of the present invention, a method for fabricating a cathode of a lithium ion secondary battery by recycling a cathode active material may include: carbonizing a binder existing in a cathode scrap of a lithium ion secondary battery by heat treating the cathode scrap of the lithium ion secondary battery in operation S1; collecting a cathode active material from the cathode scrap of the lithium ion secondary battery in operation S2; and forming a cathode of a lithium ion secondary battery without adding a conductive material in operation S3.

First, a cathode scrap of a lithium ion secondary battery (hereinafter, referred to as a cathode scrap) may be prepared in operation S0 as follows.

A cathode of a lithium ion secondary battery may have a structure in which a cathode active layer is formed on a conductive metal thin plate. The conductive metal thin plate serves as a current collector, and any metal having such a level of conductivity as to operate as the current collector may be used for the conductive metal thin plate. More specifically, the conductive metal thin plate may be an aluminum thin plate, but is not limited thereto.

The cathode active material layer may include a cathode active material, a conductive material, and a binder. An electrode reaction may occur in the cathode active material, and the electrons generated during the electrode reaction may be transferred to a current collector or external circuit through the conductive material. The binder may bind cathode active material particles together so as to maintain a form.

By mixing the cathode active material, conductive material, and binder in an organic solvent, slurry may be fabricated. By applying the slurry on the conductive metal thin plate and drying the slurry, a cathode sheet may be fabricated.

The cathode sheet may be cut into a desired form in order to be used as a cathode of a lithium ion secondary battery, and the remnants of the sheet may be collected in order to prepare a cathode scrap.

Further, by separating a cathode from a wasted lithium ion secondary battery, the cathode scrap may be prepared.

Next, by heat treating the cathode scrap, a binder existing in the cathode scrap may be carbonized in operation S1.

The cathode scrap may include a conductive metal thin plate and a cathode active material layer, and the cathode active material layer may contain a binder. The binder, which is an organic polymer material, may be pyrolyzed at high temperature and may remain in the form of carbon after the pyrolysis. This remaining carbon may function as a conductive material like carbon black. To carbonize the binder, the cathode scrap may be heat treated.

In an oxidizing atmosphere, the binder may be oxidized and may not function as a conductive material. Therefore, it is necessary to maintain an inert atmosphere or reducing atmosphere when the heat treatment is performed. To form the inert atmosphere, argon gas and nitrogen gas may be used. To form the reducing atmosphere, hydrogen gas may be used.

A heat treatment temperature may be about 400 to 600° C. Preferably, the heat treatment temperature may be about 450 to 550° C. When the heat treatment temperature is lower than about 400° C., the binder existing in the cathode scrap may not be carbonized, and the current collector may not be separated from the cathode active material layer. When the heat treatment temperature is higher than about 600° C., a phase change of the cathode active material may occur, and the crystallinity and particle diameter of the cathode active material may increase. Thus, performance of a battery may be degraded, and a great amount of energy may be consumed, which is uneconomical.

A heat treatment time may be about 30 minutes to one hour. When the heat treatment time is shorter than about 30 minutes, the binder may not be carbonized. When the heat treatment time is longer than about one hour, a phase change of the cathode active material may occur, and the crystallinity and particle diameter of the cathode active material may increase. Thus, performance of a battery may be degraded, and a great amount of energy may be consumed, which is uneconomical.

Next, the cathode active material may be collected from the cathode scrap in operation S2.

After the heat treatment, due to thermal expansion difference between the cathode active material layer and the conductive metal thin plate used as the current collector, the conductive metal thin plate used as the current collector may be easily separated from the cathode active material layer.

By grinding the separated cathode active material layer and sieving the ground cathode active material layer, cathode active material powder may be collected. For the sieving, a 200-mesh sieve may be used.

Next, without adding a conductive material to the collected cathode active material, a cathode of a lithium ion secondary battery may be formed in operation S3.

The binder may remain in a carbonized state in the collected cathode active material. Since the carbide may serve as a conductive material, when the cathode is formed by using the collected cathode active material, the conductive material may not be added. Therefore, the cost of raw materials may be reduced. Further, since a process of adding the conductive material is not necessary, a fabricating process may be simplified.

In this case, the amount of the cathode active material may be about 80 to 95 wt %, and the amount of the binder may be about 5 to 20 wt %. However, the present invention does not exclude further adding a conductive material. In some cases, the conductive material may be added by as much as about 0 to 10 wt %.

Here, to make slurry having appropriate viscosity, i.e. viscosity of about 10,000 to 30,000 cp, a sodium carboxymethyl cellulose (1 wt % in water) polymer solution may be added by as much as one to two times more than the weight of the mixture.

Further, to uniformly mix the slurry, the slurry may be stirred at a high speed of about 5,000 rpm for about 40 minutes by using a homogenizer.

A cathode of a lithium ion secondary battery may be fabricated by applying the homogenized slurry on an aluminum thin film having a thickness of about 20 μm to a certain thickness, e.g. about 80 to 250 μm, using a doctor blade technique.

The cathode active material may include LiFePO₄, but is not limited thereto.

The binder may be a water-based binder or organic binder. More specifically, a polymer solution in which sodium carboxymethyl cellulose (1 wt % in water) and styrene butadiene rubber (40 wt % in water) are mixed may be used as the binder, and polyvinylidene fluoride (PVDF) may be used as the organic binder. However, the binder is not limited thereto.

Any material capable of imparting conductivity to the cathode may be used as the conductive material. More specifically, carbon black (trade name: Denka Black) or graphite (trade name: KS6) may be used.

Any material having excellent electron conductivity may be used as the conductive metal thin plate. More specifically, the conductive metal thin plate may include at least one selected from the group consisting of an aluminum thin plate, a copper thin plate, a gold thin plate, a silver thin plate, and a platinum thin plate.

According to another exemplary embodiment of the present invention, a lithium ion secondary battery may include a cathode fabricated by a method including: carbonizing a binder existing in a cathode scrap of a lithium ion secondary battery by heat treating the cathode scrap of the lithium ion secondary battery; collecting a cathode active material from the cathode scrap of the lithium ion secondary battery; and forming a cathode of a lithium ion secondary battery without adding a conductive material to the collected cathode active material.

The present embodiment is the same as the above-described embodiment with respect to the cathode scrap, the carbonization of the binder, the collection of the cathode active material, and the conductive material.

Hereinafter, the present invention will be described in detail with reference to examples and a comparative example.

### EXAMPLE 1

First, a cathode scrap of a lithium ion secondary battery is prepared as follows:

LiFePO₄ powder is used as the cathode active material, a polymer solution in which sodium carboxymethyl cellulose (1 wt % in water) and styrene butadiene rubber (40 wt % in water) are mixed is used as the binder, and a mixture of carbon black (trade name: Denim Black) and graphite (trade name: KS6) is used as the conductive material.

The cathode active material, binder, and conductive material are mixed, and this mixture is put into an organic solvent in order to fabricate slurry by performing ball milling. Then, a cathode active material layer is formed by applying the slurry onto an aluminum thin plate. A cathode sheet for a lithium ion secondary battery is fabricated by drying the obtained structure in an oven.

The cathode sheet is cut in order to be used as a cathode of a lithium ion secondary battery, and the remnants of the sheet are collected in order to prepare a cathode scrap.

Next, the cathode scrap is put into a tube furnace, and nitrogen gas is injected thereto for about one hour in order to remove remaining oxygen in the tube furnace. Then, the cathode scrap is heat treated for about 30 minutes at a temperature of about 400° C. in an atmosphere of nitrogen. During this process, the binder is pyrolyzed and carbonized.

Next, the aluminum thin plate is physically separated from the cathode scrap. Due to thermal expansion difference caused by the heat treatment, the cathode active material layer may be easily separated from the aluminum thin plate.

The separated cathode active material layer is ground and is sieved by using a 200-mesh sieve in order to collect a LiFePO₄ cathode active material. The carbide of the binder is contained in the obtained cathode active material.

Next, about 10 g of the binder is added to about 10 g of the collected LiFePO₄ cathode active material. Then, this mixture is stirred for about 40 minutes at a speed of about 5,000 rpm by using a homogenizer in order to fabricate slurry having viscosity of about 20,000 cp. A solution in which sodium carboxymethyl cellulose (1 wt % in water) and styrene butadiene rubber (40 wt % in water) are mixed is used as the binder. The conductive material is not added.

Next, the slurry is applied onto an aluminum thin plate having a thickness of about 20 μm to a thickness of about 150 μm by using a doctor blade technique. Then, this obtained structure is dried in an oven in order to fabricate a cathode sheet for a lithium ion secondary battery.

Next, the fabricated cathode sheet is cut in order to be used as a cathode, a lithium metal plate having a thickness of about 150 μm is used as an anode, polypropylene is used as a separator, and a solution in which 1M LiPF₆ lithium salt is dissolved is injected as electrolyte into an organic solvent in which ethylene carbonate, ethyl methyl carbonate, and dimethyl carbonate are mixed in a volumetric ratio of 1:1:1 in order to fabricate a coin-type lithium ion secondary battery.

### EXAMPLE 2

A LiFePO₄ cathode active material is collected and a lithium ion secondary battery is fabricated in the same manner as described above with respect to example 1 except that a cathode scrap is heat treated at a temperature of about 500° C.

### EXAMPLE 3

A LiFePO₄ cathode active material is collected and a lithium ion secondary battery is fabricated in the same manner as described above with respect to example 1 except that a cathode scrap is heat treated at a temperature of about 600° C.

### Comparative Example

A lithium ion secondary battery is fabricated in the same manner as described above with respect to example 1 except that the LiFePO₄ collected as the cathode active material is not used and new LiFePO₄ is used, and except that a conductive material is added for fabricating a cathode.

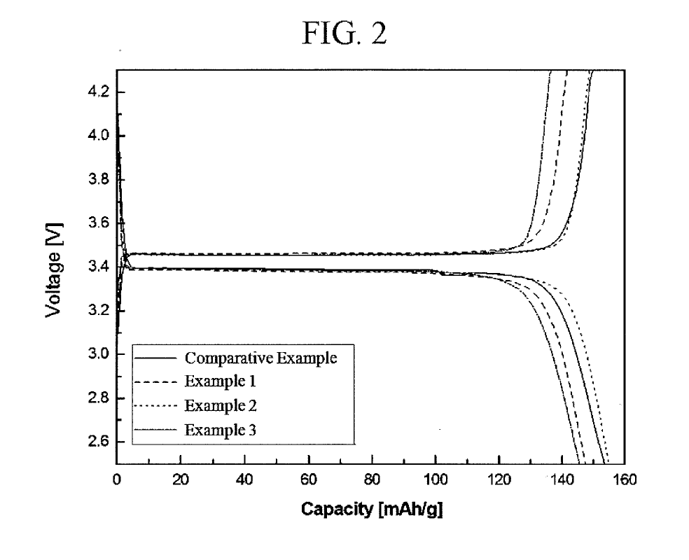

The lithium ion secondary batteries according to the examples and comparative example are evaluated in teens of capacity and cycle by using a constant-current method, and results are illustrated in FIGS. 2 to 4.

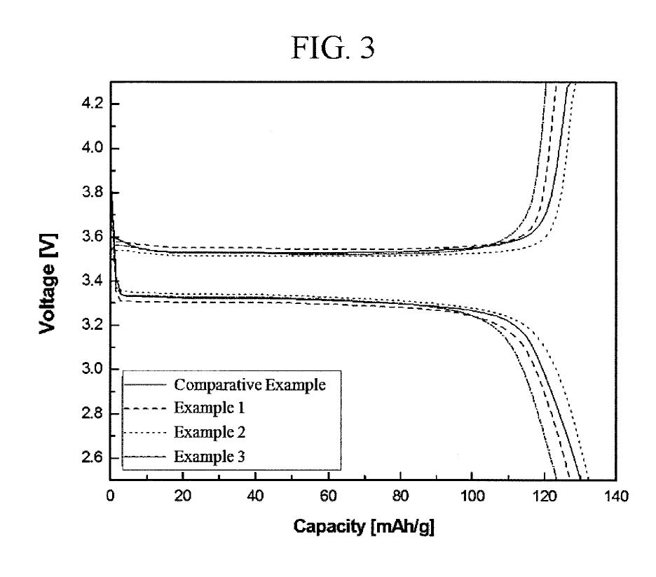

FIGS. 2 and 3 illustrate charge/discharge voltage characteristics of the lithium ion secondary batteries according to the examples and comparative example. A charge/discharge rate is varied to detect changes according to the charge/discharge rate variation. FIG. 2 illustrates a case where the charge/discharge rate is about 0.1 C, and FIG. 3 illustrates a case where the charge/discharge rate is about 1.0 C.

Referring to FIG. 2, the collected LiFePO₄ is used as the cathode active material and the conductive material is not added in the examples, and new LiFePO₄ is used as the cathode active material and the conductive material and binder are added in the comparative example.

Compared with the comparative example, examples 1 and 3 have slightly small capacities. However, it may be confirmed that this difference is not significant. In particular, it may be confirmed that example 2 has greater capacity than that of the comparative example.

Therefore, it may be confirmed that the performance of a battery is not greatly limited even though the LiFePO₄ cathode active material from the cathode scrap is recycled instead of using new LiFePO₄ cathode active material.

FIG. 3 illustrates the case where the charge/discharge rate is about 1.0 C. In comparison with the case of FIG. 2, the charge/discharge rate is faster. Referring to FIG. 3, it may be confirmed that the capacities overall are decreased in comparison with FIG. 3 (2?). Accordingly, it may be confirmed that the capacity decreases as the charge/discharge rate becomes faster.

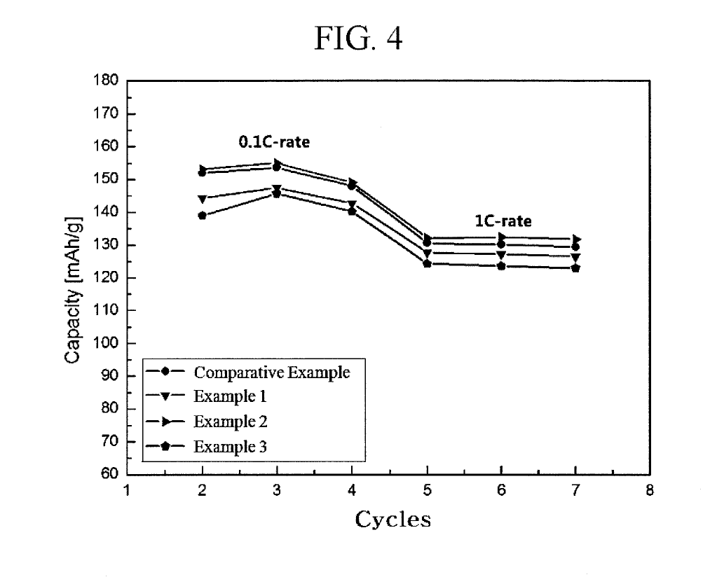

FIG. 4 is a graph illustrating the cycle performance of the lithium ion secondary batteries according to the examples and comparative example.

Referring to FIG. 4, it may be confirmed that example 2 has improved charge/discharge capacity and cycle characteristics in comparison with the comparative example. Examples 1 and 3 are a little bit inferior to the comparative example in terms of charge/discharge capacity and cycle characteristics. However, such a degree of difference does not cause degradation of battery performance, and the batteries of examples 1 and 3 may sufficiently substitute for the battery of the comparative example.

As a result, according to the above experiment, although examples 1 and 3 are a little bit inferior to the comparative example in terms of charge/discharge capacity and cycle characteristics, this difference is extremely insignificant. Therefore, even though the lithium ion secondary battery of the comparative example is substituted with the lithium ion secondary battery of example 1 or 3, the problem of degradation of battery performance does not occur.

Therefore, even though a lithium ion secondary battery is fabricated by recycling the cathode active material from the cathode scrap by using a simple method, there is no problem in terms of battery performance. Rather, recycling is environmentally friendly and reduces manufacturing cost. In particular, according to example 2, the lithium ion secondary battery of which charge/discharge capacity and cycle characteristics are more improved than those of the lithium ion secondary battery of the comparative example, may be implemented.

According to the present invention, a method for fabricating a cathode for a lithium ion secondary battery which is simple, environmentally friendly, economical, and capable of reducing manufacturing cost, and a lithium ion secondary battery fabricated thereby can be implemented.

The terminology used herein is not for delimiting the present invention but for describing the specific embodiments. The terms of a singular form may include plural forms unless otherwise specified.

The term “include” or “have” indicates existence of a feature, a number, a process, an operation, a component, or a combination thereof but does not exclude them.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method for fabricating a cathode for a lithium ion secondary battery by recycling a cathode active material, the method comprising:
carbonizing a binder existing in a cathode scrap of a lithium ion secondary battery by heat treating the cathode scrap of the lithium ion secondary battery;
collecting a cathode active material from the cathode scrap of the lithium ion secondary battery; and
forming a cathode for a lithium ion secondary battery without adding a conductive material to the collected cathode active material.

2. The method of claim 1, wherein the cathode for the lithium ion secondary battery for the carbonizing of the binder comprises a conductive thin plate and a cathode active material layer formed on the conductive thin plate, and the cathode active material layer comprises the cathode active material, conductive material, and binder.

3. The method of claim 2, wherein the conductive thin plate is a conductive metal thin plate.

4. The method of claim 3, wherein the conductive metal thin plate comprises at least one selected from the group consisting of an aluminum thin plate, a copper thin plate, a gold thin plate, a silver thin plate, and a platinum thin plate.

5. The method of claim 2, wherein the cathode active material comprises LiFePO₄.

6. The method of claim 1, wherein the heat treatment is performed at a temperature of about 400° C. to about 600° C.

7. The method of claim 1, wherein the heat treatment is performed at a temperature of about 450° C. to about 550° C.

8. The method of claim 1, wherein the heat treatment for the carbonizing of the binder is performed in an atmosphere of reducing gas or inert gas.

9. The method of claim 8, wherein hydrogen gas is used as the reducing gas.

10. The method of claim 8, wherein nitrogen gas or argon gas is used as the inert gas.

11. The method of claim 1, wherein the collecting of the cathode active material comprises grinding and sieving.

12. The method of claim 1, wherein the forming of the cathode comprises adding a binder.

13. The method of claim 12, wherein about 80 to 95 wt % of the cathode active material and about 5 to 20 wt % of the binder are added, and the total amount of the cathode active material and binder is 100 wt %.

14. The method of claim 12, wherein the binder comprises a polymer solution in which sodium carboxymethyl cellulose (1 wt % in water) and styrene butadiene rubber (40 wt % in water) are mixed.

15. A lithium ion secondary battery comprising a cathode fabricated by a method comprising: carbonizing a binder existing in a cathode scrap of a lithium ion secondary battery by heat treating the cathode scrap of the lithium ion secondary battery; collecting a cathode active material from the cathode scrap of the lithium ion secondary battery; and forming a cathode for a lithium ion secondary battery without adding a conductive material to the collected cathode active material.
